(19) United States
(12) Patent Application Publication
(10) Pub. No.: US 2014/0264004 A1
(43) Pub. Date: Sep. 18, 2014

(54) SYSTEMS AND METHODS FOR ANALYZING A SAMPLE USING A MASS SPECTROMETRY PROBE CONFIGURED TO CONTACT THE SAMPLE

(71) Applicant: Purdue Research Foundation, West Lafayette, IN (US)

(72) Inventors: Robert Graham Cooks, West Lafayette, IN (US); Alan Keith Jarmusch, Lafayette, IN (US); Kevin Scott Kerian, Lafayette, IN (US)

(73) Assignee: Purdue Research Foundation, West Lafayette, IN (US)

(21) Appl. No.: 14/209,304

(22) Filed: Mar. 13, 2014

Related U.S. Application Data
(60) Provisional application No. 61/896,697, filed on Oct. 29, 2013.
(60) Provisional application No. 61/839,189, filed on Jun. 25, 2013.
(60) Provisional application No. 61/791,100, filed on Mar. 15, 2013.

(51) Int. Cl. H01J 49/04; H01J 49/00

(52) U.S. Cl. CPC H01J 49/0409; H01J 49/0031; H01J 49/0013
USPC 250/282; 250/288

(57) ABSTRACT

The invention generally relates to systems and methods for analyzing a sample using a mass spectrometry probe having a tip that is configured to contact a sample and retain a portion of the sample once the probe has been removed from the sample.

### RELATED APPLICATIONS

The present application claims the benefit of and priority to each of U.S. provisional application Ser. No. 61/791,100, filed Mar. 15, 2013, U.S. provisional application Ser. No. 61/839,189, filed Jun. 25, 2013, and U.S. provisional application Ser. No. 61/896,697, filed Oct. 29, 2013, the content of each of which is incorporated by reference herein in its entirety.

### GOVERNMENT SUPPORT

This invention was made with government support under EB009459 and EB0115722 awarded by National Institutes of Health. The government has certain rights in the invention.

### FIELD OF THE INVENTION

The invention generally relates to systems and methods for analyzing a sample using a mass spectrometry probe having a tip that is configured to contact a sample and retain a portion of the sample once the probe has been removed from the sample.

### BACKGROUND

Ambient ionization produces ions outside a mass spectrometer from samples in their native state (Monge et al., Chemical Reviews, 2013, 113, 2269-2308; and Chen et al., Journal of the American Society for Mass Spectrometry, 2009, 20, 1947-1963). Desorption electrospray ionization (DESI; Takats et al., Journal of Mass Spectrometry, 2005, 40, 1261-1275) was reported in 2004, and since then more than forty ambient ionization methods have been described (Huang et al., Annual Review of Analytical Chemistry, 2010, 3, 43-65; Badu-Tawiah et al., Annual Review of Physical Chemistry, 2013; and Nemes et al., TrAC Trends in Analytical Chemistry, 2012, 34, 22-34).

An important characteristic of ambient ionization is speed of analysis. For example, it requires only a few seconds for the entire process of sampling, ionization, and recording of mass spectra. That feature is the result of eliminating or greatly relaxing sample pre-treatment, including avoiding separation techniques prior to mass spectrometry. Ambient ionization mass spectrometry displays wide applicability combined with high sensitivity and the high molecular specificity characteristic of mass spectrometry.

Ambient methods based upon spray ionization include DESI, nanospray desorption electrospray ionization (nanoDESI; Roach et al., Analyst, 2010, 135, 2233-2236) liquid microjunction surface-sampling probe (LMJ-SSP; Van Berkel et al., Journal of Mass Spectrometry, 2008, 43, 500-508) probe electrospray ionization (PESI; Hiraoka et al., Rapid Communications in Mass Spectrometry, 2007, 21, 3139-3144), and others. In each case, solvent and high voltage are used to generate the strong electric field needed to produce charged secondary droplets which leave the substrate carrying dissolved analyte into the mass spectrometer. The emitted charged droplets undergo coulombic fission when sufficient surface charge is accumulated as a result of solvent evaporation, eventually yielding analyte ions by mechanisms that parallel those in electrospray ionization.

A family of methods exist that rely on spray based ionization from substrates (Venter et al., Analytical Chemistry, 2013, 86, 233-249). Those methods include PAPER SPRAY (porous substrate mass spectrometry probe, Purdue Research Foundation; PS; Wang et al., Angewandte Chemie, 2010, 122, 889-892), probe electrospray ionization (PESI; Hiraoka et al., Rapid Communications in Mass Spectrometry, 2007, 21, 3139-3144), and leaf spray (LS; Chen et al., Journal of Mass Spectrometry, 2009, 44, 1469-1477). Substrate spray methods generate ions from tips, naturally present or created, and require a minute amount of sample.

Nonetheless, technical challenges remain. For example, even with the advent of systems and methods that allow for sample preparation and pre-treatment to be combined with the ionization process, sample extraction is still typically required prior to analysis by mass spectrometry.

### SUMMARY

The invention provides systems and methods for analysis of in situ samples. Aspects of the invention are accomplished using a probe having a tip configured to contact a sample and retain an analyte of the sample once the probe has been removed from the sample. Application of voltage to the probe tip, and optionally solvent, generates ions from the analyte retained on the probe. Those ions are subsequently analyzed using an ion analysis device, such as a mass spectrometer. In that manner, absorbed material can be transported from a point of origin to an analysis device without removing the sample from its native environment.

In certain aspects, the invention provides systems for analyzing a sample. Those systems include a probe having a tip including a non-porous material. The tip is configured to contact a sample and retain an analyte from the sample once the probe has been removed from the sample. An electrode is operably coupled to the probe. The system also includes an ion analysis device that includes a mass analyzer. The system is configured such that the probe is at atmospheric pressure, the mass analyzer is under vacuum, and the tip of the probe points in a direction of an inlet of the ion analysis device such that ions of the analyte expelled from the tip of the probe are received to the inlet of the ion analysis device.

The system may additionally include a solvent delivery device that is operably coupled to the probe such that solvent from the solvent delivery device is supplied to the tip of the probe. In certain embodiments, the probe includes a hollow inner bore in communication with the tip. Such a configuration allows solvent to be infused through the bore to interact with the sample to facilitate generation of ions of an analyte from the portion of the sample on the probe.

Exemplary probes include scalpels, needles (e.g., teasing needle), burrs, paper clips, etc. In certain embodiments, the tip is roughened, which facilitates retention of the analyte from the sample on tip. In other embodiments, the tip is bent with respect to a proximal portion of the probe. The tip of the probe may be composed of any conductive material, and an exemplary material is metal. In certain embodiments, the system further includes a source of nebulizing gas. The source of nebulizing gas may be configured to provide pulses of gas. Alternatively, the source of nebulizing gas may be configured to provide a continuous flow of gas.

Other aspects of the invention include methods for analyzing a sample. Those methods may involve contacting a non-porous tip of a probe to a sample such that an analyte of the sample is retained on the probe once the probe has been removed from the sample. The contacting occurs at atmospheric pressure. The probe is oriented such that the tip of the probe points in a direction of an inlet of an ion analysis device. The methods may additionally involve, applying, at atmospheric pressure, a voltage to the tip of the probe once the probe has been removed from the sample, thereby generating ions at atmospheric pressure of the analyte from the portion of the sample retained on the probe. The methods may additionally involve transferring the ions from atmospheric pressure into a mass analyzer of the ion analysis device to thereby analyze the ions. The mass analyzer is under vacuum. In certain embodiments, methods of the invention further involve applying, at atmospheric pressure, solvent to the tip of the probe.

Systems and methods of the invention may be used to analyze any sample. In certain embodiments, the sample contains one or more microorganisms. Systems and methods of the invention are particularly useful for analyzing tissue samples, specifically in vivo tissue samples or tissue that has been excised from its origin. With in vivo tissue samples, the probe is touched to the tissue, and a portion of the tissue is retained by the probe. The retained portion is minimal, such that the native tissue sample is undamaged. The portion retained by the probe is then analyzed.

With excised tissue, the probe is typically a metal probe that can be directly coupled to a high voltage source. In that manner, the same instrument can be used to excise the tissue and serve as the platform for generating ions of one or more analytes in the tissue. Such a system can be considered an indirect coupling between the excised tissue and the high voltage source, i.e., the high voltage source is coupled to the tissue via the metal probe. In other embodiments, the high voltage source is directly coupled to the excised tissue without an intervening probe. Systems of the invention encompass both direct and indirect coupling of the high voltage source to the tissue. In either embodiment, ions of one or more analytes in the tissue are generated directly from the tissue, without any further sample preparation. In some embodiments, a discrete amount of solvent is applied to the tissue along with the high voltage. A mass analyzer is operably associated with the tissue, such that generated ions from the tissue are received by the mass analyzer.

Another aspect of the invention provides systems that include a probe having a metallic proximal portion and a distal tip composed of a porous material. The distal tip is configured to contact a sample and retain an analyte of the sample once the probe has been removed from the sample. An electrode is operably coupled to the metallic proximal portion of the probe. The system also includes a mass analyzer. The system may further include a solvent delivery device that is operably coupled to the probe such that solvent from the solvent delivery device is supplied to the tip of the probe. The mass analyzer may be for a mass spectrometer or a miniature mass spectrometer.

Another aspect of the invention provides a method for analyzing a sample that involves providing a probe including a metallic proximal portion and a distal tip composed of a porous material. The distal tip of the probe is contacted to a sample such that an analyte of the sample is retained on the probe once the probe has been removed from the sample. A voltage is then applied to the probe via the metallic proximal portion once the probe has been removed from the sample, thereby generating ions of the analyte retained on the probe. The method then involves analyzing the ions. The method may further include applying a solvent to the distal tip. Analyzing may be by any method known in the art, and in certain embodiments may involve transferring the ions into a mass spectrometer or miniature mass spectrometer.

### BRIEF DESCRIPTION OF THE DRAWINGS

FIGS. 1-3 show brain spectra of a mouse obtained using Touch Spray.

FIG. 4 shows a spectrum obtained using a methanol wetted Touch Spray probe to wipe the outside of an orange to detect agrochemicals. Imazalil gives rise to the ion m/z 297.

FIG. 5 shows ms/ms spectra of ions seen in FIG. 4.

FIG. 6 shows spectra obtained using Touch Spray from dip experiments on rat blood. The top spectrum was obtained using ACN as the spray solvent and the bottom was obtained using an ACN solution with 10 ppm betaine aldehyde. The BA-cholesterol product, m/z 488.5, is clearly seen in the bottom spectrum.

FIG. 7 shows spectra obtained using Touch Spray from dried bovine blood spots (5 uL) on wood using a methanol wetted teasing probe. The top spectrum was taken after drying the bovine blood on wood for 24 hr at room temperature in open air. The bottom spectrum was taken after drying the bovine blood on wood for 10 days at 37 c in an incubator.

FIG. 8 shows spectra from a mouse brain line scan.

FIG. 9 is a zoom of the mouse brain H&E to increase visibility of the touched regions. Boxes are about 2 mm×2 mm.

FIG. 10 spectra show the phospholipid m/z region of tumor tissue from radical prostatectomy case S13-2011 biopsy number 6 produced by DESI and TS respectively. Two adjacent sections confirm tumor region of the tissue.

FIG. 11 show data acquired from the adjacent normal tissue region of biopsy number 6.

FIG. 12 shows betaine aldehyde (10 ppm) reaction with cholesterol (100 ppm)—product m/z 488.5 positive mode.

FIG. 13 shows Girard's reagent P (few ppm) reaction with adrenosterone (10 ppm)—product m/z 435.08 positive mode. m/z 301 is adrenosterone (precursor),

FIG. 14 Silver (4 ppm) adduct of cholesteryl linoleate (10 ppm)—m/z 755.4 and 757.4. At 10 ppm cholesteryl linoleate did not show up in the full scan in positive or negative mode.

FIG. 15 Mouse brain positive mode (typical spectrum seen for grey matter) and mouse brain positive mode using silver nitrate solution (4 ppm) in ACN as spray solvent (m/z 901 and 903 are due to ubiquinone q9 and m/z 969 and 971 are ubiquinone q10)

FIG. 16 shows a workflow for analyzing bacteria using Touch Spray.

FIG. 17 shows a negative-mode spectrum obtained from a dried 5 uL bovine blood spot off on wood.

FIG. 18 shows a negative-mode spectrum obtained from a dried 5 uL canine blood spot on glass.

FIG. 19 shows a positive-mode spectrum obtained from doing a dip experiment with the teasing probe used to sample blood.

FIG. 20 shows a positive-mode spectrum obtained from a dry spiked bovine blood spot on glass.

FIG. 21 shows a spectrum obtained by spraying 2 uL of the mixed drug solution with each drug at a 100 ppb concentration.

FIG. 22 shows a spectrum obtained by doing a “dip experiment” where the teasing probe was quickly dipped into the mixed drug solution with each drug at a 100 ppb concentration.

FIG. 23 shows a spectrum obtained by extracting the drugs off of a wood panel using a methanol wetted teasing tube.

FIG. 24 shows spectrum of white and grey tissue matter in a mouse brain.

FIG. 25 shows results from spraying a 5 uL/min 50 ppb solution of cocaine using an “on/off” method of applying 0 kV then 5 kV for 12 seconds respectively (except for the last peak in the ion chromatogram which we sprayed for 36 seconds continuously).

FIGS. 26-27 are examples of “touching” a solution of cocaine.

FIG. 28 shows a spectrum of cocaine obtained using Touch Spray.

FIG. 29 shows a spectrum of ascorbic acid detected using touch spray.

FIGS. 30-31 show additional spectra of mouse brain.

FIG. 32 illustrates the result of a spray MS taken using a hypodermic needle to probe the surface of human uterine tissue.

FIG. 33 demonstrates Touch Spray on prostate tissue.

FIG. 34 shows mass spectra of different bacteria obtained using Touch Spray.

FIGS. 35A-B show mass spectra of different gram positive bacteria obtained using Touch Spray.

FIGS. 36A-F show mass spectra of different gram negative bacteria obtained using Touch Spray.

FIG. 37 is a graph showing clustering of different microorganisms.

FIG. 38 is a similarity cluster of different organisms.

FIG. 39 shows a workflow comparing a mass spectrum of an unknown microorganism to a database including mass spectra of known microorganisms to identify the unknown microorganism.

FIG. 40 panels A-C show the Touch Spray process. Sampling of solids (panel A) and liquids (panel B) by Touch Spray ionization using an angled teasing needle. Panel C shows that the tip of the probe is oriented to point at an inlet of the mass spectrometer. Application of high voltage and solvent causes release of analyte-containing charged droplets, which are directed to the inlet of the mass spectrometer.

FIG. 41 is a photograph showing emitted droplets observed under bright-field microscopy.

FIG. 42 (Upper left) H&E stain of a transverse mouse brain section after repeat sampling, annotated, by TS-MS (Lower left) Sampling point 1, corresponding to the olfactory bulb which contained unique lipids detected at m/z 806.3 and 909.4 (Right) TS-MS from annotated sampling points displaying various levels of white and gray matter.

FIG. 43 shows negative ion mode TS-MS spectra of a mouse olfactory bulb with DESI-MS spectra from the same region (inset). Modified from reference Eberlin et al. (Angewandte Chemie International Edition, 2010, 49, 873-876).

FIG. 44A-C show coronal mouse brain section with six evenly spaced spots depicting the symmetry of the brain and reproducibility of TS.

FIG. 45 panel A DESI-MS and panel B TS-MS of region outlined in panel C corresponding to prostate malignancy as determined by histopathological evaluation.

FIG. 46 shows negative ion mode TS-MS displaying E. coli phospholipids in a sample consisting of 1% of a single colony, showing phospholipids and the chloride adduct of CHAPS, a surfactant added to the spray solution.

FIG. 47 shows positive mode TS-MS produced by touching a dried blood spot containing 10 ng of cocaine on blue cloth.

FIG. 48 shows positive ion mode TS-MS of illicit drugs, methamphetamine, MDMA, and cocaine, at 400 ppb in homogenous solution sampled via a single dip of a touch spray probe.

FIG. 49 shows full scan calibration curve of Imatinib. Data points represent the average value for repeat analysis (N=5) and error bars corresponding to the standard deviation. Linear regression performed by unweighted least squares analysis from 1 ppm to 13.3 ppm.

FIG. 50 shows detection of imazalil and thiabendazole in positive mode TS-MS obtained from a non-organic orange.

FIG. 51 shows positive mode TS-MS of cholesteryl linoleate with a silver adduct from the addition of silver nitrate into the spray solvent.

FIG. 52 shows positive mode reactive TS-MS using Girard's P reagent (left) and hydroxylamine (right) with adrenosterone

FIG. 53 shows that the detection of cholesterol from bovine blood was accomplished using betaine aldehyde which reacts with a poorly ionizable hydroxyl functionality creating a positively-charged quaternary amine derivative. The top spectrum depicts positive mode TS-MS of human blood using pure MeOH as the solvent. The bottom, a positive mode TS-MS spectrum of human blood where betaine aldehyde has been added to the spray solvent to react with cholesterol, m/z 488.5.

FIG. 54 shows a Touch Spray set-up including a pump.

FIG. 55 panel A shows a schematic of sampling from culture or patient throat swab and subsequent analysis by TS-MS. FIG. 55 panel B shows negative ionization mode TS-MS spectra of a single colony of S. pyogenes sampled from culture. Peaks of negative relative abundance and those annotated by asterisks are attributable to background. Positive relative abundance peaks denote phospholipids detected.

FIG. 56A shows negative mode TS-MS spectra of mouse brain sampled with various swab materials including cotton, polyester, and rayon (from top-bottom). FIG. 56B shows zoom of GPL for various swab materials tested.

FIG. 57 is an image of TS-MS using rayon medical swab.

FIG. 58 panel A shows Beta-hemolysis of S. pyogenes grown on TSA with 5% sheep blood. FIG. 58 panel B shows sampling of a single, isolated colony of S. pyogenes—background appears dark due to photography.

FIG. 59A shows negative mode TS-MS spectra of 3 triplicate S. pyogenes measurements acquired using a rayon medical swab including Swab and Agar backgrounds. FIG. 59B shows zoom of GPL region.

FIG. 60 panel A shows negative mode TS-MS spectra of S. pyogenes, and FIG. 60 panel B shows negative mode TS-MS spectra of S. agalactiae, each sampled using one colony from culture with m/z annotated.

FIG. 61 shows negative ionization mode TS-MS spectrum displaying the phospholipid region containing ions corresponding to bacterial and human components of the simulated throat swab.

FIG. 62 shows negative mode TS-MS of human saliva containing cheek epithelial cells.

### DETAILED DESCRIPTION

The invention generally relates to systems and methods that use a probe having a tip that is configured to contact a sample and retain a portion of the sample once the probe has been removed from the sample. There are numerous different techniques, probe embodiments, and methods discussed throughout this application. Any of the techniques discussed herein may be referred to as Touch Spray, which is a general method of analysis.

Certain aspects of the invention generally relate to systems and methods for analyzing a sample using a mass spectrometry probe having a tip composed of a non-porous material that is configured to contact a sample and retain an analyte of the sample once the probe has been removed from the sample. In this embodiment of Touch Spray, the sample, such as tissue surface, in vivo, is touched with a suitable probe (scalpel, needle, burr, paper clip, etc.). A small quantity of material is transferred to the probe from the probe's touch of a specific point, line or area of the sample. Ions are produced by application of solvent and a voltage. Pneumatic force is not required.

Mass spectral profiles are acquired rapidly (typically less than approximately one (1) second) with the spatial resolution determined directly by the probe's touch. Mass spectral profiles may also be averaged over time, such as approximately twenty (20) seconds. By sampling a point or a number of points the method of analyzing the tissue surface is fast with no sample preparation. The method of analysis can also be undertaken intra-operatively which may be important in establishing disease margins on a time scale that is useful during surgery.

An embodiment of the Touch Spray process is shown in FIG. 40. Certain embodiments of Touch spray (TS) uses a probe (e.g. needle) to sample material and solvent and an electrical potential to desorb analyte and transfer it in ionic form into a mass spectrometer. The sample may be a solid, liquid or gas. In certain embodiments, Touch Spray ionization is aimed specifically at in situ analysis of complex samples. Analytes are transferred from a particular location in the sample using a roughed probe. Subsequently, spray ionization (FIG. 41) transfers the ionized analyte to the mass spectrometer for analysis. The TS method incorporates a manual method of collecting a MS sample: sampling is remote to the mass spectrometer and after manual transfer onto a probe, MS is performed directly from the sampling device.

It is not necessary to use a specific probe material or that it have a particular physical form: the transfer of a minute amount of material for MS analysis can be achieved by touching, scratching, dipping, swiping, or otherwise attaching sample material. The probe tip is then aligned with the mass spectrometer, high voltage is applied, solvent is optionally added, and mass spectra are recorded. In certain embodiments, as described herein, the TS probe tip is aligned with the atmospheric inlet (0.5-20 mm away) and an appropriate voltage (3.0-5.0 kV) is applied to generate a stable electrospray signal without a corona discharge. When necessary, solvent may be either applied manually via pipette (0.1-2 μL, which provided mass spectral signals lasting only a few seconds) or continuously via a syringe pump (yielding continuous signal until analyte exhaustion, typically >1 min).

One suitable probe is a teasing needle (FIG. 40); these are metallic, possess a sharp tip, and are roughened. The metallic and roughened features appear to be beneficial when sampling and transferring material, such as biological tissue. The crevasses in the roughened surface hold material during sample transfer and analysis, facilitating analyte extraction. In addition, in the case of teasing needles, the angled feature was found to increase reliability, as it accommodated solvent application and was observed to promote solvent flow. In certain embodiments, complete wetting of the probe's surface improved extraction of analytes and emission of solvent microdroplets.

In certain embodiments, at least the tips of the probes of the invention are non-porous. Non-porous refers to materials that do not include through-holes that allow liquid or gas to pass through the material, exiting the other opposite side. Exemplary, non-porous materials include but are not limited to metal or plastics. An exemplary porous material is paper.

Non-porous probes of the invention can include a roughened tip. The roughening can be crevasses, grooves, indentations, etc., that allow material to collect within. The roughened surface does not make the non-porous material porous. Rather it provides portions of the surface in which sample material can collect. The collected sample material does not enter or pass-through the remainder of the probe tip once collected in such features. Accordingly, non-porous material that includes crevasses, grooves, indentations, etc. is still considered non-porous material for purposes of the invention. For example, a metal probe tip that includes crevasses, grooves, indentations, etc. is a tip of a probe that comprises non-porous material.

Touch Spray is performed by two basic steps: (1) touching a sample with a probe in order to transfer analyte from the sample to the probe and (2) spraying analyte on the probe into a mass spectrometer. The first step includes touching the surface of a sample, such as tissue, glass, wood, powder, or other materials, with a probe that, in certain embodiments, includes an end such as a metallic point and/or a roughened surface. The step of touching a sample can be performed in a variety of ways including dry, wet, and dip. A probe may be moistened by the addition of 1-2 μL of extractive solvent. A wet touch may facilitate the transfer of analytes from the sample to the probe surface. A wetted probe including solvated analyte may be allowed to dry. Drying under these conditions typically takes less than 30 seconds but can vary based on the solvent composition and volume of solvent applied to the probe. After the previously wetted probe has essentially dried, the probe with analyte is placed in front of a mass spectrometer and analyzed in a procedural manner similar to electrospray ionization or dry touch.

Another aspect of touching is the amount or degree of contact between the probe and the sample. A probe may touch a sample in a variety of ways including point, line, and area. A point touch may include a single point touch such as when the probe includes a tip or a multiple point touch such as when the probe includes an area at an end. A point touch of a surface of a sample may include a small circular motion of the probe and may affect a small amount of sample material, typically not more than 1 mm in diameter. A line touch occurs when the probe is touched to a surface at a starting point and traversed to another point. The movement may be by straight line or by a scratch.

The step of spraying includes the application of solvent and voltage to the probe placed in close proximity to the inlet of a mass spectrometer. The mass spectrometer is capable of analyzing the analyte in a procedural manner similar to electrospray ionization. The step of spraying analyte from the probe into a mass spectrometer can be performed in a variety of ways including variations in solvent, solvent application, application in high voltage, and probe placement.

The application of spray solvent to the probe can be performed in a variety of ways including two methods: (1) discontinuous and (2) continuous. Discontinuous application includes applying approximately 1-2 μL of solvent to the probe. Typically solvent is applied using a micropipettor to aid in obtaining reproducible results. The location of solvent application (i.e, where solvent lands on the probe), often no more than a few millimeters, is important for electrospray formation, spray stability, and thus the quality of mass spectra obtained. The location of solvent application varies based on probe geometry, surface, and spray solvent composition. Continuous application of solvent includes spray solvent delivered via a solvent transfer line, connected to a solvent source such as a syringe, and possibly driven by a syringe pump. The location of spray solvent application is important to proper functioning, analogous to the discontinuous method. Continuous application of the spray solvent allows for on/off switching by either removing the application of high voltage to the probe or ceasing solvent flow via the syringe pump.

The application of high voltage (for example, within the range of approximately 3-approximately 5 kilovolts) to the probe can be made directly via metal connector or inductively. The location of high voltage application is less important to spray formation in the case of a metallic probe, but is more important in less conductive materials. High voltage application may be applied after probe placement in an optional holding device and prior or essentially simultaneous to solvent application.

Touch Spray has numerous applications. For example, Touch Spray can be used to identify positive margins in a manner that will allow surgical intervention during the operative procedure. In certain embodiments, Touch Spray identifies lipid markers that detect positive margins in the operating room to enable additional resection if needed and detect markers of cancer aggressiveness. Given that cancer patients may have positive margins, the impact of additional resection for residual disease will be determined in a relatively short time frame.

Touch Spray provides a method for intra-surgical diagnostics by MS on a point-to-point basis. An advantage of Touch Spray over other mass spectrometry techniques is its ability to sample tissues in vivo and immediately analyze ex vivo. Touch Spray allows diagnostic information to be obtained without the removal of potentially healthy tissue.

Spot analysis by Touch Spray allows for detailed and automated comparisons of tissue lipid profiles with those associated with pathological conditions. This ambient ionization spray-based technique provides information on a wide range of lipids. Furthermore this technique works in both positive and negative ion modes. Both modes are complementary and similarly informative. Hence, the wide range of lipid molecular information can be utilized in defining cancer in current and retrospective examinations.

Systems and methods of the invention find particular use in cancer diagnostics and in the operating room to determine tumor margins. Currently, tissue is first removed and then examined by a pathologist. The pathologist evaluates whether or not the removed tissue has margins of healthy tissue. The pathologist relays the evaluation to the surgeon which gives the surgeon information regarding whether or not to remove more tissue. Using touch spray, the surgeon can make the decision to resect more tissue or not to resect based on mass spectral data suggesting that the investigated sample, in this case tissue, is diseased or not. It is envisioned that under ideal conditions analysis by touch spray may result in resection of only cancerous tissue, leaving almost all healthy tissue behind.

Touch Spray can be used to analyze tissue, as described in the Examples below. In certain embodiments, for in vivo sampling, Touch Spray can be performed using a probe fitted with a small, flattened needle connected to a small reservoir of solvent that will be touched onto tissue to allow a small amount of material to adhere. The probe will be held in front of a miniature mass spectrometer, a voltage will be applied to the probe and the solvent will cause a spray of droplets into the MS.

Reactive Touch Spray possesses the ability to perform chemical derivatization concurrently with mass spectral analysis, allowing for specific analytes to be distinguished and/or enhanced. Reactions are not confined to covalent bond formation but include reactive intermediates and gas-phase adduction products as well. The reagents used in Reactive Touch Spray can be added to the spray solvent, continuously or discontinuously, or applied to the probe prior to touching. Touch Spray can be used in the detection of lipids from fresh blood as well as dried blood spots using the appropriate sampling methods. The lipids patterns are useful in differentiating disease states. Similarly, drugs, including illicit drugs (cocaine, MDMA, heroin, and methampthamine), can also be detected in both fresh blood and dried blood spots. Enhancement of biofluid constituents is possible using Reactive Touch Spray. Touch spray can be used in the detection of agrochemicals, including fungicides (e.g. imazalil and thiabendazole) on the surfaces of foodstuff, including fruits (e.g. oranges).

In other embodiments, the tissue is excised tissue. With excised tissue, the probe is typically a metal probe that can be directly coupled to a high voltage source. In that manner, the same instrument can be used to excise the tissue and serve as the platform for generating ions of one or more analytes in the tissue. Such a system can be considered an indirect coupling between the excised tissue and the high voltage source, i.e., the high voltage source is coupled to the tissue via the metal probe. Such a set-up is described above and in the examples herein. In those embodiments, a portion of tissue is excised from an in vivo source. The excised portion is retained on the probe, such as at the probe tip. The probe is coupled to a high voltage source so that voltage is applied through the probe and to the tissue. Ions of one or more analytes are then generated in the tissue, which ions are received by a mass analyzer.

In other embodiments, the high voltage source is directly coupled to the excised tissue without an intervening probe. In those embodiments, a surgical instrument is used to excise a portion of in vivo tissue. A high voltage source is then directly coupled to the tissue, such as via a metal clip (e.g., a copper clip) that is attached to the tissue. Application of voltage directly to the tissue results in generations of ions of one or more analytes from the tissue, which ions are received by a mass analyzer. In direct coupling embodiments, the tissue may be solely held by the clip or may also be held by any suitable holder, such as a sample cassette. Exemplary sample cassettes are described, for example in PCT/US12/40513, the content of which is incorporated by reference herein in its entirety. Other sample holding devices are described for example in U.S. 2012/0119079, the content of which is incorporated by reference herein in its entirety.

Systems of the invention encompass both direct and indirect coupling of the high voltage source to the tissue, such as by the embodiments described above. Ions of one or more analytes in the tissue are generated directly from the tissue, without any further sample preparation. In some embodiments, a discrete amount of solvent is applied to the tissue along with the high voltage.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

### EXAMPLES

Touch spray (TS) ionization is a spray-based ambient ionization method capable of in situ sampling of complex mixtures. The rapid, reproducible, and specific chemical information obtainable from biological tissue includes mouse brain and human prostate cancer. Differentiation of specific anatomical regions and disease states based on lipids detected in the negative ionization mode appears are possible. Application in the detection of bacteria is shown, the detected lipids allowing for differentiation of bacteria. TS-MS of solutions, including blood, allow for numerous applications in forensics (e.g. illicit drugs) and medicine (e.g. therapeutic drug monitoring). The user-guided nature of TS allows for the unique sampling abilities. Further, simultaneous ionization and chemical derivatization enhances the signal for specific analytes or groups of analytes. As discussed herein, TS-MS can be combined with miniaturized mass spectrometer systems to allow for in situ sampling, ionization, and mass analysis.

### Example 1

### Analyzing Tissue Using Touch Spray

The lipid composition of mouse brain tissue has been extensively studied using ambient ionization mass spectrometry (e.g. DESI; Eberlin, If et al., Angewandte Chemie International Edition, 2010, 49, 873-876) and therefore constitutes a biological standard by which to qualitatively measure the performance of touch spray ionization. A minute amount of cellular and extracellular material can be transferred to a touch spray probe using light abrasive force on the biological material. Mouse brain tissue sections were sampled in that manner removing material in a circle (diameter <1 mm). Touch spray mass spectra displayed in FIG. 42 are similar to those acquired with DESI, FIG. 43, in the negative ion mode is dominated by signals due to fatty acids (m/z<300), fatty acid dimers (m/z 300-700), and glycerophospholipids (m/z 700-1000). The relative abundances of m/z 888.5 (main constituent from previous studies, sulfatide 24:1), 788.5 (phosphatidylserine 36:1), 834.5 (phosphatidylserine 40:6), and 885.5 (phosphatidylinositol 38:4) were used to qualitatively assess neural composition (white and grey matter) as shown in FIG. 42. The transverse plane of mouse brain possesses left-right hemisphere symmetry, visible in the various staining features (e.g. cerebellum and corpus callosum). Touch spray was performed at six positions (FIG. 42) annotated upon the H&E stain. The touch spray mass spectra from the mouse olfactory bulb (FIG. 42, point 1) displaced unique ions detected at m/z 806.5 (PS 38:6) and 909.5 (PI 40:6) corresponding to parallel findings using DESI. Similarly, the mass spectra recorded from point 2 indicated a high percentage of white matter, corresponding to the corpus callosum. The spectra recorded at point 5 show a high percentage of gray matter (periaqueductal gray and/or cerebellum). At other points a mixture of gray and white matter was observed with point 3 corresponding to the thalamus, point 4 to periaqueductal gray with white matter potentially from the posterior commissure, and point 6 primarily white matter from the granular layer of the cerebellum with some gray matter.

The reproducibility of touch spray was assessed using coronal mouse brain sections. These sections are comprised of either grey or white matter each possessing different glycerophospholipids, reflected in the spectra, and whose distribution is symmetrical between right and left hemispheres. Touch spray was performed at six equally spaced points across one coronal section (FIG. 44). Mass spectra were reproducible in terms of the prominent glycerophospholipids ions seen and also in terms of their approximate relative intensities. They were similar between points of related neural composition; for example, A and F indicated grey matter which produces patterns including a base peak at m/z 834.5 and major peaks at m/z 788.5 and 885.5 whereas B and E displayed an ion m/z 888.5 with a higher ratio of m/z 888.5 to 834.5 than m/z 788.5 or 885.5 to 834.5 indicating the presence of white matter.

Brain spectra of the mouse FROM Touch Spray analysis are shown in FIGS. 1-3. The spectrum in FIG. 2 represents a typical spectrum obtained when probing the G1 region of a mouse brain. The insert on FIG. 1 is the spectrum shown in the 3D mouse brain using DESI. Although the relative intensities of the peaks differ between the two methods, the pattern between the DESI spectrum and the Touch Spray spectrum is very similar. FIG. 3 shows a typical spectrum seen when probing white matter, same section as G1 touch experiment.

FIGS. 30-31 shows additional spectra of mouse brain.

### Example 2

### Chemical Detection Using Touch Spray

FIG. 4 shows a spectrum obtained using a methanol wetted Touch Spray probe to wipe the outside of an orange to detect any agrochemicals. Imazalil, m/z 297, was detected and the ms/ms is shown in FIG. 5.

FIG. 6 shows spectra obtained using Touch Spray from dip experiments on rat blood. The top spectrum was obtained using ACN as the spray solvent and the bottom was obtained using an ACN solution with 10 ppm betaine aldehyde. The BA-cholesterol product, m/z 488.5, is clearly seen in the bottom spectrum.

FIG. 7 shows spectra obtained using Touch Spray from dried bovine blood spots (5 uL) on wood using a methanol wetted teasing probe. The top spectrum was taken after drying the bovine blood on wood for 24 hr at room temperature in open air. The bottom spectrum was taken after drying the bovine blood on wood for 10 days at 37 c in an incubator. The phospholipid pattern seen from the blood spot dried for 10 days at 37 c still matches up quite well to that of the blood spot dried for 24 hr.

FIG. 29 shows a spectrum of ascorbic acid detected using touch spray.

### Example 3

### Touch Spray Using a Dry Probe

All touch spray experiments on tissue in this example were performed using a dry probe and then spraying methanol. The spectra are from mouse brain, prostate specimen, and reactive touch spray. Reaction experiments were done by dipping the touch spray probe into a solution mixture of cholesterol, cholesteryl linoleate, and adrenosterone and then spraying with a specific reagent.

FIG. 8 shows spectra from a mouse brain line scan.

FIG. 9 is a zoom of the mouse brain H&E to increase visibility of the touched regions. Boxes are about 2 mm×2 mm.

FIG. 10 spectra show the phospholipid m/z region of tumor tissue from radical prostatectomy case S13-2011 biopsy number 6 produced by DESI and TS respectively. Two adjacent sections confirm tumor region of the tissue.

FIG. 11 show data acquired from the adjacent normal tissue region of biopsy number 6.

FIG. 12 shows betaine aldehyde (10 ppm) reaction with cholesterol (100 ppm)—product m/z 488.5 positive mode.

FIG. 13 shows Girard's reagent P (few ppm) reaction with adrenosterone (10 ppm)—product m/z 435.08 positive mode. m/z 301 is adrenosterone (precursor),

FIG. 14 Silver (4 ppm) adduct of cholesteryl linoleate (10 ppm)—m/z 755.4 and 757.4. At 10 ppm cholesteryl linoleate did not show up in the full scan in positive or negative mode.

FIG. 15 Mouse brain positive mode (typical spectrum seen for grey matter) and mouse brain positive mode using silver nitrate solution (4 ppm) in ACN as spray solvent (m/z 901 and 903 are Ubiquinone q9 and m/z 969 and 971 are Ubiquinone q10, there may be some TAGs as well)

### Example 4

### Touch Spray for Microorganism Analysis and Identification

Interest in in vitro detection and identification of bacteria by mass spectrometry has increased significantly (Havlicek et al., Analytical Chemistry, 2012, 85, 790-797). The ability to directly detect biomolecules such as proteins and lipids by matrix assisted laser desorption ionization (MALDI; Dubois et al., Journal of Clinical Microbiology, 2012) and electrospray ionization (ESI), respectively, has reduced diagnosis time while improving accuracy due to high molecular specificity. Touch spray was investigated for its applicability to in vitro detection of microorganisms.

FIG. 16 shows a workflow for analyzing microorganisms, such as bacteria, viruses, protozoans (also spelled protozoon), or fungi, using Touch Spray. The workflow shows that a probe tip is touched to a sample, in this example, an agar plate having cultured bacteria. The probe may be swabbed or moved in any manner over the plate. The probe may have a hollow inner bore or may have a solid core. The probe is then removed from the plate and solvent and voltage are applied to the probe so that ions are generated that go into a mass spectrometer for analysis. For hollow probes, solvent may be infused through the bore. For solid core probes, solvent may flow over an outside of the probe. Any mass spectrometer known in the art may be used, and in certain embodiments, the mass spectrometer is a miniature mass spectrometer, such as that described for example in Gao et al. (Anal. Chem., 80:7198-7205, 2008) and Hou et al. (Anal. Chem., 83:1857-1861, 2011), the content of each of which is incorporated herein by reference herein in its entirety.

The sample is not limited to an agar plate, any solid or liquid sample can be analyzed. In certain embodiments, the sample is a human tissue or body fluid. The sample may be an in vivo sample or an extracted sample. In certain embodiments, the methods of the invention are sensitive enough to analyze and identify microorganisms without first culturing the microorganism. In some embodiments, the microorganism is cultured prior to analysis, however, methods of the invention allow for decreased culture time over that used in standard procedures.

FIG. 34 shows mass spectra of different bacteria obtained using Touch Spray. FIGS. 35A-B show mass spectra of different gram positive bacteria obtained using Touch Spray. FIGS. 36A-F show mass spectra of different gram negative bacteria obtained using Touch Spray.

In certain embodiments, a minute amount of material, as little as 1% of a single bacterial colony, was required for mass spectral analysis. The data presented in FIG. 46 were acquired in the negative ionization mode with automatic gain control (AGC) in a burst of signal lasting just a few seconds. Repeated sampling of the E. coli culture yielded ionized lipids of identical m/z values and relative spectral intensity, while absolute intensity varied with sampling. The spectra contained phospholipids in a profile from approximately m/z 660-780, including odd-carbon number fatty acid phospholipids (e.g. m/z 719.5, phosphatidylglycerol 32:1). It was determined empirically that the addition of CHAPS, a surfactant, to the methanol spray solvent increased and stabilized the TS spectra (Badu-Tawiah et al., Journal of the American Society for Mass Spectrometry, 2010, 21, 1423-1431). Addition of CHAPS at 0.01% was determined to have the most beneficial effect without undue interference from the CHAPS chloride adduct (m/z 649.8).

Aspects of the invention also provide methods of identifying an organism, e.g., a microorganism. The methods include obtaining a mass spectrum of an organism using Touch Spray probes of the invention and correlating/comparing the mass spectrum with a database that includes mass spectra of known organisms (FIG. 37-39). With use of methods of the invention, the organism can be identified and classified not just at a genus and species level, but also at a sub-species (strain), a sub-strain, and/or an isolate level. The featured methods offer fast, accurate, and detailed information for identifying organisms. The methods can be used in a clinical setting, e.g., a human or veterinary setting; or in an environmental, industrial or forensic/public safety setting (e.g., clinical or industrial microbiology, food safety testing, ground water testing, air testing, contamination testing, and the like). In essence, the invention is useful in any setting in which the detection and/or identification of a microorganism is necessary or desirable.

A database for use in the invention can include a similarity cluster. The database can include a mass spectrum from at least one member of the Clade of the organism. The database can include a mass spectrum from at least one subspecies of the organism. The database can include a mass spectrum from a genus, a species, a strain, a sub-strain, or an isolate of the organism. The database can include a mass spectrum with motifs common to a genus, a species, a strain, a sub-strain, or an isolate of the organism.

The database(s) used with the methods described herein includes mass spectrum associated with known organisms (FIG. 39). The mass spectra are typically annotated to show if they were acquired in positive or negative mode. The database(s) can contain information for a large number of isolates, e.g., about 200, about 300, about 400, about 500, about 600, about 700, about 800, about 900, about 1,000, about 1,500, about 2,000, about 3,000, about 5,000, about 10,000 or more isolates. In addition, the mass spectra of the database contain annotated information (a similarity index or cluster, see FIGS. 37 and 38) regarding motifs common to genus, species, sub-species (strain), sub-strain, and/or isolates for various organisms. The large number of the isolates and the information regarding specific motifs allows for accurate and rapid identification of an organism. The data in FIG. 37 show that there is separation of fungi and bacteria, a separation between gram negative and gram positive bacteria, and a separation of gram negative species.

To generate similarity clusters, each mass spectrum is aligned against every other mass spectrum. From these alignments, a pair-wise alignment analysis is performed to determine “percent dissimilarity” between the members of the pair (FIG. 38). Briefly, this clustering method works by initially placing each entry in its own cluster, then iteratively joining the two nearest clusters, where the distance between two clusters is the smallest dissimilarity between a point in one cluster and a point in the other cluster.

Various organisms, e.g., viruses, and various microorganisms, e.g., bacteria, protists, and fungi, can be identified with the methods featured herein. The sample containing the organism to be identified can be a human sample, e.g., a tissue sample, e.g., epithelial (e.g., skin), connective (e.g., blood and bone), muscle, and nervous tissue, or a secretion sample, e.g., saliva, urine, tears, and feces sample. The sample can also be a non-human sample, e.g., a horse, camel, llama, cow, sheep, goat, pig, dog, cat, weasel, rodent, bird, reptile, and insect sample. The sample can also be from a plant, water source, food, air, soil, plants, or other environmental or industrial sources.

The methods described herein include correlating the mass spectrum from the unknown organism with a database that includes mass spectra of known organisms. The methods involve comparing each of the mass spectra from the unknown organism from a sample against each of the entries in the database, and then combining match probabilities across different spectra to create an overall match probability (FIG. 39).

### Example 5

### Rapid Detection of Strep Throat Causing Bacterium by Touch Spray—Mass Spectrometry

Strep throat causing Streptococcus pyogenes was detected in vitro and in simulated clinical samples by touch spray ionization-mass spectrometry using medical swabs, demonstrating the development of a MS-based strep test.

Introduction—Bacterial Pharyngitis (Strep Throat)

Pharyngitis is diagnosed >10 million times annually in the United States (Gieseker et al., Pediatrics, 2003, 111, e666-e670), of which pediatric cases have an economic impact of an estimated 224-539 million dollars (Shulman et al., Clinical Infectious Diseases, 2012, 55, e86-e102). Streptococci infection (i.e. strep throat) accounts for as much as 30% (Clerc et al., Clinical Microbiology and Infection, 2010, 16, 1054-1061) of all pharyngitis cases with minor occurrences of Neisseria gonorrhoeae, Corynebacterium diphtheria, Arcanobacterium haemolyticum, etc. (Bisno, New England Journal of Medicine, 2001, 344, 205-211) Group A streptococcal (GAS), Streptococcus pyogenes, infection is the target of screening methods as it responsible for nearly all Streptococci caused bacterial pharyngitis (Bisno, New England Journal of Medicine, 2001, 344, 205-211).

Diagnosis of strep throat is crucial in children, elderly patients, and regions in which rheumatic and scarlet fever are prevalent as life-threatening complications are possible and patient discomfort can be significant. Clinical symptoms often do not allow for ready differentiation between bacterial and viral infection, requiring rapid screening method. Patients are commonly tested for the presence of GAS at the point-of-care using a rapid antigen detection test (RADT) providing results in 15-20 minutes (Campbell et al., Advanced Techniques in Diagnostic Microbiology, Springer, 2013, pp. 31-51). RADTs are commonly based on detecting group A streptococcal carbohydrate, a bacterial membrane component, using lateral flow immunochromatography, providing a visual indication of test results. The rate of true positives of RADTs is ˜70-90%; however, the rate of false negatives is substantial (˜10-20%; Gerber et al., Clinical microbiology reviews, 2004, 17, 571-580; Santos et al., Brazilian Journal of Infectious Diseases, 2003, 7, 297-300; Camurdan et al., International journal of pediatric otorhinolaryngology, 2008, 72, 1203-1206; and Ö. Küçük et al., The Indian Journal of Pediatrics, 2013, 1-5). Studies have shown that personnel training and interpretation are critical for reliable test results (Fox et al., Journal of clinical microbiology, 2006, 44, 3918-3922). By comparison, throat culture, the gold standard for diagnosis of GAS infection, possess a rate of true positives >90% with negligible false negatives. However, throat culture is used primarily as a confirmatory test with definitive results requiring 24-48 hours for growth and interpretation, delaying antimicrobial treatment. The performance of RADT tests are inversed from those desired in typical screening methods in which false negatives should be mitigated at the expense of false positives. Therefore in clinical practice, positive RADT results support treatment while negative results commonly lead to further testing using additional RADTs or culture. RADT false negatives contribute to physician over-prescription for fear of subsequent development of life-threating conditions (i.e. chronic rheumatic heart disease).

Methods

All experiments were performed on a linear ion trap mass spectrometer (LTQ, Thermo Scientific, San Jose, Calif.). Full scan spectra were collected in the negative ionization mode with automatic gain control from m/z 100-2000. The following instrument parameters were used: capillary temperature 275° C., capillary voltage −50V, tube lens voltage −100V, spray voltage −5.0 kV, maximum injection time 50 ms, and 2 microscans. Swab were affixed to a ring stand via three finger clamp in front of the MS inlet, vertically respective to ground, at approximately 8-10 mm away and 5-6 mm above the inlet. Thirty-eight to forty microliters of solvent (methanol) was applied manually via pipette to the swab. High voltage was applied to the metallic handle via the instrument high voltage cable and copper clip.

Touch spray-MS investigations were performed upon S. pyogenes using sterile medical swabs possessing an aluminium handle and rayon swab (Copan Diagnostics, Murrieta, Calif.) unless otherwise noted. Additional swabs were tested, manufactured by Puritan Medical Products (Guilford, Me.), including swabs constructed of various materials as well as various swab geometries (i.e. greater or lesser curvature at apex). HPLC-grade methanol was purchased from Mallinckrodt Baker Inc., Phillipsburg, N.J.

Streptococcus pyogenes and Streptococcus agalactiae were provided by bioMérieux, Inc. (Hazelwood, Mo.) as frozen samples stored at −80° C. in TSAB cryovials. Bacteria were cultured on TSA with 5% sheep blood (Remel, Lenexa, Kans.) at 35±1° C. for approximately 24 h and sub-cultured for an additional 48 h prior to MS analysis. A VWR forced air incubator (Chicago, Ill.) was used for culturing and all materials were autoclaved prior to disposal.

Touch Spray Using Medical Swabs

Medical swabs were evaluated for use in touch spray ionization-mass spectrometry. The intent being to extract the chemical information relevant to patient care, namely the detection of S. pyogenes in this application, in a minimally invasive, non-destructive procedure. Medical swabs offer direct sampling of many potential sources of diagnostic information such as bacterial culture and patient throat swabs, FIG. 55, panel A. Sampling is performed remote from the mass spectrometer, no preparative steps are required prior to analysis, and ionization occurs directly from the sampling device.

The medical swabs were in no way altered from their original construction, except removal from sterile packages prior to use. Various types of medical swabs were tested and evaluated using mouse brain tissue. All swab tip materials (cotton, rayon, and polyester) tested yielded mass spectra (FIGS. 56A-B). The relative abundance of lipids detected in the negative ionization mode were highly reminiscent of those of DESI-MS spectra, particularly in rayon and cotton tipped swabs. Glycerophospholipids (GPL) in the range from m/z 700-900, with particular emphasis to m/z 788 (PS 36:1), 834 (PS 40:6), 885 (PI 38:4), and 888 (ST 20:4), correctly reflecting the primarily gray matter composition of the samples. Polyester swabs provided the lowest signal in the GPL region of the spectra and contained substantial background ions, m/z 349.5 and 377.5. Cotton swabs provided more background in the m/z 500-600 region, opposed to rayon which yielded the least spectral complexity resulting from the swab. Swabs possessing metallic handles were observed to produce the most stable spray conditions, opposed to paper or plastic handles, likely a results of decreased resistivity of the material. While not commonly use in medical practice, metallic handle swabs are commercially available and would necessitate an insignificant change in current medical practice.

The hemispherical shape of the swabs necessitated higher voltages for droplet emission than with previous Touch Spray probes, but well within instrumentation capability. The orientation of swabs to the mass spectrometer was determined to effect signal quality and reproducibility significantly. Swabs oriented vertically with respect the ground (FIG. 57) provided the most reproducibly, as the variability in emitted droplets direction was reduced.

In Vitro Detection of S. pyogenes

A single, isolated colony of S. pyogenes (estimated 106-8 bacteria) was sampled using a rayon tipped medical swab (FIG. 58). The colony was adsorbed to the swab's tip by gently touching and subsequently transferred to the mass spectrometer for analysis. Solvent and high voltage were applied using a pipette and copper clip, respectively. Mass spectral signal was obtained for ˜5-10 seconds, varying slightly with the quantity of solvent applied, constituting the entire amount of time required in detection. Background MS signals corresponding to the swab, solvent, and agar were noted, primarily m/z<600, presented in FIG. 59. Background and S. pyogenes negative ionization mode mass spectra were normalized by their respective total ion current (TIC) values and subtracted, displayed in FIG. 55, panel B. Peaks associated with the background are reflected in negative normalized relative and those annotated with an asterisk. On the contrary, a series of peaks with positive normalized relative abundances were attributed to S. pyogenes, identified as bacterial lipids: m/z 717.6 (PG 32:2), m/z 719.6 (PG 32:1), m/z 745.6 (PG 34:2), m/z 747.6 (PG 34:1), m/z 771.4 (PG 36:3) and m/z 773.6 (PG 36:2). The lipids detected and their relative ratios are nearly identical to those reported previously by electrospray ionization-mass spectrometry analysis of S. pyogenes. (Rosch, Journal of bacteriology, 2007, 189, 801-806). S-MS analysis of S. pyogenes provided adequate reproducibility, shown in FIG. 59, provided approximately the same amount of material was sampled.

In addition to in vitro detection of S. pyogenes, the capability for TS-MS using medical swabs to distinguish different Streptococcus infections was tested. TS-MS spectra resulting from S. pyogenes and Streptococcus agalactiae, a beta-hemolytic group B streptococcus (GBS), are displayed in FIG. 60. The lipids profiles of the two Streptococci are different, visually, in the m/z 600-800 region. S. agalactiae possesses a greater relative abundance of m/z 665.5, 687.4, 691.6, and 717.6, while ions at m/z 719.6 and 747.6 displayed an inversed relative abundance with S. pyogenes. The detection of S. agalactiae by TS-MS represents another possible application of this methodology, as rapid GBS detection is sought-after in neonatal care (Bergeron et al., New England Journal of Medicine, 2000, 343, 175-179). The ability for TS-MS to distinguish bacteria possessing similar culturing features (i.e. beta-hemolysis) is notable, while the ability to differentiate Streptococci species is more clinically relevant. TS using medical swabs allows for performing two different RADT diagnostic tests using one MS based methodology.

Simulated Clinical Sample Detection of S. pyogenes

A clinical throat swab was simulated using human saliva containing cheek epithelial cells and S. pyogenes. A rayon medical swab was dipped into ˜1 mL of human saliva containing cheek cells, absorbing an estimated 40 μL of saliva, and then subsequent used to sample a single colony of S. pyogenes from culture-simulating a clinical throat swab. The swab was then analyzed by TS-MS without pretreatment, yielding abundant MS signal. A predominate ion at m/z 465.5, cholesterol sulfate, was detected and is presumably of human epithelial cell origin, consistent with literature reports of buccal cell compositions of approximately 7.8% (Wertz et al., Comparative Biochemistry and Physiology Part B: Comparative Biochemistry, 1986, 83, 529-531). The phospholipid region (m/z 700-900), FIG. 61, contained previous detected ions corresponding to bacterial lipids while additional ions at m/z 737.4, 739.4, 786.4 (PS 36:2), 788.5, 794.5 (PC 34:1+Cl−), 820.5, and 822.6 were detected. Bacterial lipids, m/z 719.5 and 773.6 were similar in relative abundance to in vitro experiments whereas m/z 745.5 and 747.6 differed. The difference was determined to be the convolution of bacterial and human lipids at those m/z values. A TS-MS spectrum of human saliva with cheek epithelial cells, FIG. 62, possessed the additional peaks listed above including m/z 745.5 and 747.6. Regardless, odd carbon chain phosphatidylglycerols at m/z 719.5 and m/z 773.6 were only detected when S. pyogenes was present. Little effect was observed from the saliva, assuming lipids stem only from human epithelial cells, although matrix effects are certainly present (i.e. ionization suppression) and might vary between patients' saliva. The chemical specificity afforded by MS allows for the deconvolution of bacterial and human lipids using post-acquisition processing, which can be further enhanced with additional stages of mass analysis (i.e. MS²).

Conclusion

Touch spray-MS performed using medical swabs allowed for the rapid detection of S. pyogenes requiring only seconds to obtain data. Definitive detection of S. pyogenes using a single colony was performed in vitro and also from simulated throat swabs. Further, in vitro experimentation provided visual differentiation of S. pyogenes and S. agalactiae, the latter having significant neonatal care application in regards to rapid detection, and a testament to the chemical specificity provided by MS-based methods. The data shows that Touch Spray was able to distinguish human from bacteria lipids.

Additionally, the ability to detect bacterial and human lipids concurrently in clinical samples provides additional data pertinent to patient affliction. Applications in therapeutic drug monitoring, drug testing (Di Corcia et al., Journal of Chromatography B, 2013), and forensic applications are also envisioned as great benefit exists when switching from detection in blood to saliva.

### Example 6

### Touch Spray for Analyzing Biofluids

FIG. 17 shows a negative-mode spectrum obtained from a dried 5 uL bovine blood spot off of wood. This dried blood spot was dried for 24 hours in the fume hood. Methanol was used to wet the teasing probe to touch the dried blood spot. The probe was allowed to dry and then used pure methanol to spray. m/z 810 peak is a very complex set of phospholipids.

FIG. 18 shows a negative-mode spectrum obtained from a dried 5 uL canine blood spot off of glass. Dry time was about ˜20-30 minutes. Again a methanol wetted teasing probe was used to touch the dried blood spot, probe was dried, and then pure methanol was used to spray. Again m/z 810 was not seen to dominate the PL region, but it is interesting to note that the bovine and canine blood spectra are significantly different than each other.

FIG. 19 shows a positive-mode spectrum obtained from doing a dip experiment with the teasing probe into some spiked blood. The spiked bovine blood had final concentrations of 10 ppm for both cocaine and heroin. The dry teasing probe was dipped into a 10 uL sample of the fresh wet blood, allowed to dry after dipping, and pure methanol was used as the spray solvent.

FIG. 20 shows a positive-mode spectrum obtained from a dry spiked bovine blood spot on glass. 5 uL of the 10 ppm cocaine and heroin blood sample was dried on a glass slide, which should be 50 ng of each drug. A methanol wetted teasing probe was used to extract the sample off the glass and pure methanol was used to spray.

### Example 7

### Touch Spray for Detecting Illicit Drugs

Forensics, in particular illicit drug analysis, often requires the ability to detect compounds in situ from matrices including powders, drug residues on surfaces including clothing, and illicit drugs in solution. Mass spectrometry is certainly capable of analyzing all of these types of samples when using various types of sample preparation. Touch spray offers a method by which to analyze these sample types without preparative steps. Drug residues on clothing typically require extraction in solvents whereas with TS, the material can be lightly rubbed absorbing minute amount of drugs while removing negligible amounts of the cloth. This ability was demonstrated by the detection of cocaine from a dried blood spot containing 10 ng of the spiked drug on blue cloth, FIG. 47. A homogenous solution containing 400 ppb each of MDMA, cocaine, and methamphetamine was sampled by dipping the TS probe into the solution and dried at ambient temperature (<1 minute). The mass spectrum (FIG. 48) was recorded by the addition of spray solvent and a high voltage; it displays the ions at m/z 150.3, 194.3, and 304.3 for each of the drugs in the solution, respectively.

In another study a mixed drug solution: Methamphetamine, Cocaine, MDMA, and Heroin in methanol was prepared. FIG. 21 shows a spectrum obtained by spraying 2 uL of the mixed drug solution with each drug at a 100 ppb concentration.

FIG. 22 shows a spectrum obtained by doing a “dip experiment” where the teasing probe was quickly dipped into the mixed drug solution with each drug at a 100 ppb concentration. The probe was dried in the desiccator and then sprayed off of using 2 uL of pure methanol.

FIG. 23 shows a spectrum obtained by extracting the drugs off of a wood panel using a methanol wetted teasing tube. The wood panel was spotted with 5 uL of the mixed drug solution with each drug having a concentration of 10 ppm except for methamphetamine which was at 1 ppm. This should be 50 ng of each cocaine, MDMA, and heroin as well as 5 ng of methamphetamine spread across a ˜1 sq in area. The probe was then sprayed off of using 2 uL of pure methanol.

FIG. 28 shows a spectrum of cocaine obtained using Touch Spray.

### Example 8

### Touch Spray for Margin Detection in Tissue

FIG. 24 shows spectrum of white and grey tissue matter in a mouse brain. The data show that touch spray can differentiate different areas of the brain, grey matter vs white matter, by doing a “line scan” across the mouse brain. A teasing probe was used to investigate the brain tissue every ˜1.5 mm, except for the second spot which was repeated. It is clear which spectrum corresponds to white matter and which spectrum corresponds to grey matter based on the change in m/z 885 vs m/z 888 relative abundances. The only spectrum that may not be so clear cut is number 5 where m/z 885 and 888 peaks are much closer to a 1:1 ratio than the other white matter spectra shown. It is interesting to note that spectrum number 5 was taken from the right side of the brain which should pretty much be a minor image of the left side, but in this mouse brain section it is clearly not. This leads us to believe that spectrum number five represents data obtained from the margin of some grey and white matter, which seems plausible based on the H&E stain also attached. Note that each of the touched areas are about 750 microns in diameter, except for the 2nd one of course.

### Example 9

### Touch Spray with Continuous Flow

Touch Spray can be used with continuous flow solvent addition. Most applications of touch spray only require brief recording of the MS signal to obtain the desired information, as outlined above. However, if the application dictates a longer signal duration, touch spray can be coupled to a solvent delivery system (solvent pump, such as a syringe/syringe pump) to provide solvent at controlled flow rate to produce stable ion currents. The solvent is added continuously at the same location where discrete additions of solvent produce spectra, yielding a signal that lasts until analyte exhaustion. An illustrative embodiment is shown in FIG. 54, including parameters determined used with the bent teasing probe.

FIG. 25 shows results from spraying a 5 uL/min 50 ppb solution of cocaine using an “on/off” method of applying 0 kV then 5 kV for 12 seconds respectively (except for the last peak in the ion chromatogram which we sprayed for 36 seconds continuously). The spectrum shown is an average of the first peak in the ion chromatogram, labeled with an orange line. The bottom ion chromatogram is a zoom of the first peak in the full ion chromatogram to show its stability.

FIGS. 26-27 are examples of “touching” a solution of cocaine. The teasing probe was dipped into a 50 ppb and 1 ppm solution of cocaine respectively and then drying the probe in the electronic dessicator. We sprayed pure MeOH at 5 uL/min and could see an exponential decay of the m/z 304.25 peak in the ion chromatogram. The spectrum associated with each of these experiments were taken from the highest intensity in the ion chromatogram.

### Example 10

### Touch Spray for Uterine and Prostate Tissue

The ability to discriminate prostate malignancy from non-malignant states is vital for improving the care of patients, and could be furthered by advances in molecular-based diagnostics. DESI-MS can be used to distinguish cancer from normal tissue in human brain tumors and to classify tumor subtypes, grades, and tumor cell concentrations (Eberlin et al., Proceedings of the National Academy of Sciences, 2013). TS was applied to prostate cancer to assess malignant and non-malignant states. Prostate cancer tissue from radical prostatectomy specimens was evaluated with TS using DESI imaging to validate the TS data. Samples were collected using a disposable biopsy gun and sectioned to allow evaluation by histopathology in serial sections (<50 μm).

DESI and TS spectra acquired from a region of malignant prostate cancer, determined by histopathology, are presented in FIG. 45 panels A-B, respectively. The H&E stained biopsy section shown in FIG. 45 panel C is a sample analyzed by DESI-MS with the cancerous region outlined. TS-MS was performed on the adjacent section. The phospholipid region (m/z 720-900) was observed to possess many similarities between the two methods such as the ratio and abundance of ions at m/z 786.5 (PS 36:2), 788.5 (PS 36:1), 861.5 (PI 36:4), 863.5 (PI 36:3), and 885.5 (PI 38:4). The major differences seen between the spectra were the chlorinated phosphotidylcholine adducts present in the TS spectrum at m/z 792.5 (PC 34:2)/794.5 (PC 34:1), 818.5 (PC 36:3)/820.5 (PC 36:2), and 844.5 (PC 38:4)/846.5 (PC 38:3). The chlorinated adducts in the TS spectrum indicate a lower salt tolerance in TS than in DESI (Jackson et al, Journal of the American Society for Mass Spectrometry, 2007, 18, 2218-2225).

Likewise, data shown in FIG. 33 demonstrate Touch Spray on prostate tissue. The data show MS lipid profiles consistent with those obtained in previous studies with DESI-MS.

Touch Spray has also been demonstrated in uterine tissue. FIG. 32 illustrates the result of a spray MS taken using a hypodermic needle to probe the surface of human uterine tissue.

### Example 11

### Therapeutic Drugs

Therapeutic drug monitoring aids in maintaining drug concentrations within the beneficial range, maximizing therapeutic effect while minimizing the risk of harmful overdosing or wasteful undosing. Ambient ionization methods such as PAPER SPRAY (porous substrate mass spectrometry probe, Purdue Research Foundation) have used whole dried blood or whole blood mixed with a coagulant to quantitatively measure the concentrations of pharmaceuticals (Espy et al., The Analyst, 2012, 137, 2344-2349). Whole bovine blood spiked with imatinib, a therapeutic used for the treatment of chronic myelogenous leukemia, and with its deuterated isotopomer added as internal standard, were analyzed over a range of concentrations.

Using the teasing probe, blood was sampled by dipping once directly into the blood to a fixed depth, waiting <1 min to dry after dipping, and analyzing directly afterwards. The quantitative performance was similar to that of PAPER SPRAY (porous substrate mass spectrometry probe, Purdue Research Foundation) with a linear response across the concentration range tested (FIG. 49; Wang et al., Angewandte Chemie, 2010, 49, 877-880). It could be increased further using MS/MS. Furthermore, the percentage error (n=5) was <10% for imatinib concentrations greater than 1 ppm, a value within FDA guidelines (see Table 1).

TABLE 1
Percent Error Calculations of Imatinib Calibration Curve

| Concentration Imatinib (ppm) | Percent Error (%) |
|---|---|
| 1.00 | 8.94 |
| 1.67 | 0.688 |
| 3.33 | 0.309 |
| 6.67 | 1.62 |
| 13.3 | −2.05 |

It is envisioned that a modified TS probe may be useful as a semi-quantitative tool that could be used as a finger-prick device which could be directly used to measure the concentration of therapeutics in whole blood.

### Example 12

### Residual Agrochemical Detection in Foods

Agrochemicals are applied to foods in an attempt to prolong crop quality while attempting to limit potentially adverse health effects. Oranges and other citrus fruits are commonly treated (systemically or sprayed post-harvest) with fungicides such as thiabendazole, leaving a trace amount of material on the surface of the orange peel. Agrochemical levels are monitored and regulated in the United States, typically by chromatographic separation prior to MS analysis. This procedure is not readily accomplishing in situ, limiting thorough screening of foodstuffs; however, fungicides have previously been reported to be monitored using paper spray ionization in situ (Wiley et al., Analyst, 2010, 135, 971-979).

A non-organic orange purchased from a national grocer was subjected to analysis by TS, in which the probe was used to sample ˜4 cm2 area of the peel. The spectrum, FIG. 50, includes ions due to protonated thiabendazole (m/z 202) and imazalil (m/z 297). The acquired spectrum matches previously reported fungicides detected from non-organic oranges using additional ambient ionization methods (i.e. low temperature plasma; Soparawalla et al., Analyst, 2011, 136, 4392-4396).

### Example 13

### Reactive Touch Spray

TS-MS experiments exploiting simultaneous chemical derivatization and ionization (i.e. reactive ambient ionization) were explored. Derivatized versions of analytes often give greater signals in MS analysis of complex mixtures. The use of appropriate reagents allows reduction of complex spectra via analyte signal enhancement or characteristic m/z value shifts. Reactive touch spray was explored with known types of ambient reactions including non-covalent adduct formation, (e.g. silver adduction of olefins; Gonzalez-Serrano et al., PloS one, 2013, 8, e74981) and covalent bond formation (e.g. betaine aldehyde formation alcohols; Wu et al., Analytical Chemistry, 2009, 81, 7618-7624). Cholesteroyl lineolate and adrenosterone were sampled from homogenous solution in a dipping fashion by TS. The unsaturated aliphatic functionality of cholesteroyl lineolate was reacted with silver nitrate (4 ppm, acetonitrile) forming non-covalent adducts detected at m/z 755.4 and 757.4 (FIG. 51) corresponding to [¹⁰⁷Ag+cholesteroyl lineolate] and [¹⁰⁹Ag+cholesteroyl lineolate]. Covalent bond forming reactions targeting the ketone functional group in adrenosterone, a cholesterol-related hormone, were accomplished using Girard's Reagent P and hydroxylamine (FIG. 52). The detection of cholesterol from bovine blood was accomplished using betaine aldehyde which reacts with a poorly ionizable hydroxyl functionality creating a positively-charged quaternary amine derivative (FIG. 53).

What is claimed is:

1. A system for analyzing a sample, the system comprising:
a probe including a tip comprised of non-porous material, the tip being configured to contact a sample and retain an analyte of the sample once the probe has been removed from the sample;
an electrode operably coupled to the probe; and
an ion analysis device that comprises a mass analyzer; wherein the system is configured such that the probe is at atmospheric pressure, the mass analyzer is under vacuum, and the tip of the probe points in a direction of an inlet of the ion analysis device such that ions expelled from the tip of the probe are received to the inlet of the ion analysis device.

2. The system according to claim 1, further comprising a solvent delivery device that is operably coupled to the probe such that solvent from the solvent delivery device is supplied to the tip of the probe.

3. The system according to claim 1, wherein the probe comprises a hollow inner bore in communication with the tip.

4. The method according to claim 1, wherein an outer surface of the tip is roughened.

5. The method according to claim 1, wherein the tip is bent with respect to a proximal portion of the probe.

6. The method according to claim 5, wherein the tip is metal.

7. The system according to claim 1, wherein the mass analyzer is for a mass spectrometer or a miniature mass spectrometer.

8. A method for analyzing a sample, the method comprising:
contacting a non-porous tip of a probe to a sample such that an analyte of the sample is retained on the probe once the probe has been removed from the sample, wherein the contacting occurs at atmospheric pressure;
orienting the probe such that the tip of the probe points in a direction of an inlet of an ion analysis device;
applying, at atmospheric pressure, a voltage to the tip of the probe once the probe has been removed from the sample, thereby generating ions at atmospheric pressure of the analyte retained on the probe; and
transferring the ions from atmospheric pressure into a mass analyzer of the ion analysis device to thereby analyze the ions, wherein the mass analyzer is under vacuum.

9. The method according to claim 8, further comprising applying, at atmospheric pressure, solvent to the tip of the probe.

10. The method according to claim 8, wherein an outer surface of the tip is roughened.

11. The method according to claim 8, wherein the tip is bent with respect to a proximal portion of the probe.

12. The method according to claim 8, wherein analyzing uses a mass spectrometer or miniature mass spectrometer.

13. The method according to claim 8, wherein the sample is a tissue sample.

14. The method according to claim 8, wherein the tissue sample is an in vivo tissue sample.

15. A system for analyzing a sample, the system comprising:
a probe comprising a metallic proximal portion and a distal tip comprised of a porous material, the distal tip being configured to contact a sample and retain an analyte of the sample once the probe has been removed from the sample;
an electrode operably coupled to the metallic proximal portion of the probe; and
a mass analyzer.

16. The system according to claim 15, further comprising a solvent delivery device that is operably coupled to the probe such that solvent from the solvent delivery device is supplied to the tip of the probe.

17. The system according to claim 15, wherein the mass analyzer is for a mass spectrometer or a miniature mass spectrometer.

18. A method for analyzing a sample, the method comprising:
providing a probe comprising a metallic proximal portion and a distal tip comprised of a porous material;
contacting the distal tip of the probe to a sample such that an analyte of the sample is retained on the probe once the probe has been removed from the sample;
applying a voltage to the probe via the metallic proximal portion once the probe has been removed from the sample, thereby generating ions of the analyte retained on the probe; and
analyzing the ions.

19. The method according to claim 18, further comprising applying a solvent to the distal tip.

20. The method according to claim 18, wherein analyzing comprises transferring the ions into a mass spectrometer or miniature mass spectrometer.
